(19) United States
(12) Patent Application Publication
(10) Pub. No.: US 2014/0337274 A1
(43) Pub. Date: Nov. 13, 2014

(54) SYSTEM AND METHOD FOR ANALYZING BIG DATA IN A NETWORK ENVIRONMENT

(71) Applicant: RANDOM LOGICS LLC, RICHARDSON, TX (US)

(72) Inventor: SUNIL UNNIKRISHNAN, RICHARDSON, TX (US)

(73) Assignee: RANDOM LOGICS LLC, RICHARDSON, TX (US)

(21) Appl. No.: 13/975,567

(22) Filed: Aug. 26, 2013

Related U.S. Application Data
(60) Provisional application No. 61/821,851, filed on May 10, 2013.

(51) Int. Cl. G06N 5/04

(52) U.S. Cl. CPC G06N 5/047
USPC 706/48

(57) ABSTRACT

An example method for analyzing big data in a network environment is provided and includes extracting a data set from big data stored in a network environment, detecting a pattern in the data set, and enabling labels based on the pattern, where each label indicates a specific condition associated with the big data, and the labels are searched to answer a query regarding the big data. In specific embodiments, detecting the pattern includes capturing gradients between each consecutive adjacent data points in the data set, aggregating the gradients into a gradient data set, dividing the gradient data set into windows, calculating a statistical parameter of interest for each window, aggregating the statistical parameters into a derived data set, and repeating the dividing, the calculating and the aggregating on derived data sets over windows of successively larger sizes until a pattern is detected.

### CROSS-REFERENCE TO RELATED APPLICATION

This application claims the benefit of priority under 35 U.S.C. §119(e) to U.S. Provisional Application Ser. No. 61/821,851, entitled “SYSTEM AND METHOD FOR ANALYZING BIG DATA IN A NETWORK ENVIRONMENT” filed May 10, 2013, which is hereby incorporated by reference in its entirety.

### TECHNICAL FIELD

This disclosure relates in general to the data analysis and, more particularly, to a system and method for analyzing big data in a network environment.

### BACKGROUND

The amount of data in the world has been increasing over time, and analyzing large data sets, called big data, will likely become a basis of competition, supporting productivity growth, innovation, and consumer surplus, according to recent research statistics. For example, general market sectors such as healthcare, retail, manufacturing and personal-location data tend to generate big data. Analysis of big data can make information transparent and usable at much higher rate. As organizations create, store and analyze more data in digital form, they can improve their performance on everything from product inventories to employee productivity. Intelligent data collection and analysis can facilitate better management decisions and forecasting. In addition, big data can potentially allow narrower segmentation of customers and consequently more precisely tailored products or services. Sophisticated big data analytics can be used to develop and improve products and services.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating a system and method for analyzing big data in a network environment according to an example embodiment;

FIG. 2 is a simplified block diagram illustrating example details according to an embodiment of the system;

FIG. 3 is a simplified block diagram illustrating another example embodiment of the system;

FIG. 4 is a simplified block diagram illustrating example details of an embodiment of the system;

FIG. 5 is a simplified block diagram illustrating example details of an embodiment of the system;

FIG. 6 is a simplified flow diagram illustrating potential example operations that may be associated with an embodiment the system;

FIG. 7 is a simplified flow diagram illustrating other potential example operations that may be associated with an embodiment the system and

FIG. 8 is a simplified flow diagram illustrating yet other potential example operations that may be associated with an embodiment the system.

### DETAILED DESCRIPTION OF EXAMPLE EMBODIMENTS

### Overview

An example method for analyzing big data in a network environment is provided and includes extracting a data set from big data stored in a network environment, detecting a pattern in the data set, and enabling labels based on the pattern, where each label indicates a specific condition associated with the big data, and the labels are searched to answer a query regarding the big data. In specific embodiments, detecting the pattern includes capturing gradients between each consecutive adjacent data points in the data set, aggregating the gradients into a gradient data set, dividing the gradient data set into windows, calculating a statistical parameter of interest for each window, aggregating the statistical parameters into a derived data set, and repeating the dividing, the calculating and the aggregating on derived data sets over windows of successively larger sizes until a pattern is detected.

### Example Embodiments

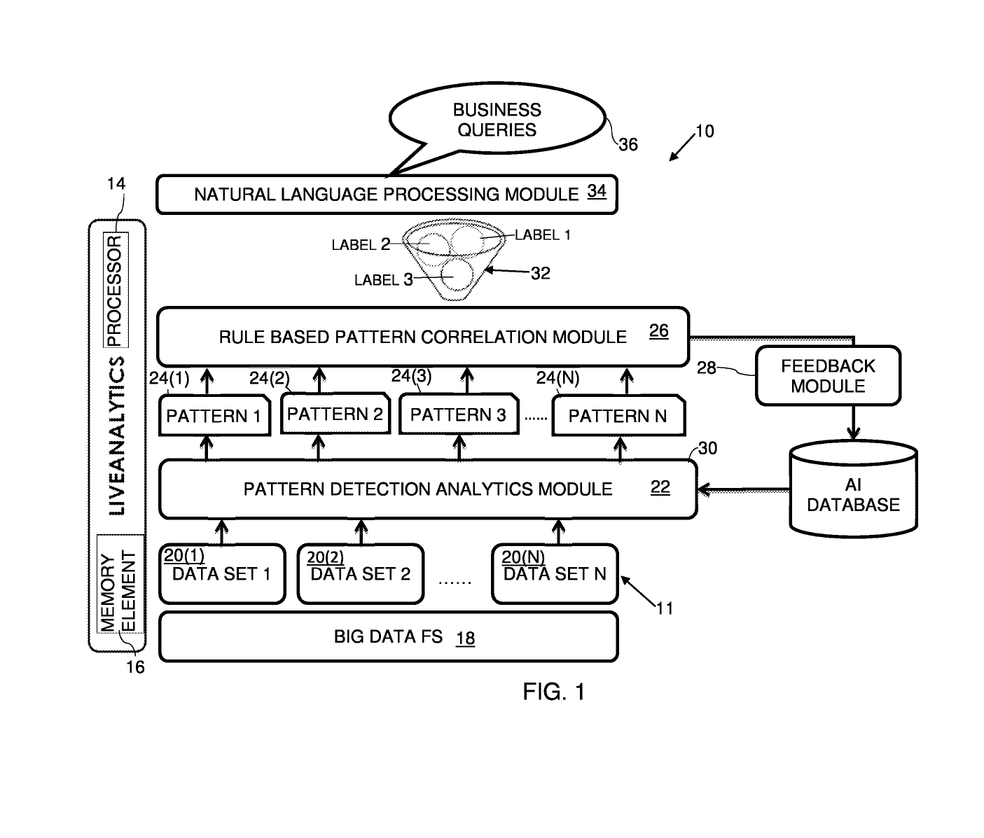

Turning to FIG. 1, FIG. 1 is a simplified block diagram illustrating an embodiment of a system 10 for analyzing big data in a network environment. System 10 includes network 11 with a Liveanalytics™ 12 comprising a module for analyzing big data and including a processor 14 and a memory element 16. Liveanalytics 12 may extract data from a big data file system (FS) 18 and generate one or more data sets 20(1)-20(N). Data sets 20(1)-20(N) may be fed to a pattern detection analytics module 22, which can extract patterns 24(1)-24(N). Patterns 24(1)-24(N) may be fed to a rule based pattern correlation module 26, which can identify correlations among patterns 24(1)-24(N) based on one or more rules. A feedback module 28 may provide feedback about the correlation accuracy to an Artificial Intelligence (Al) database 30. Al database 30 may save learnt data and use the stored information to modify the pattern detection algorithm of pattern detection analytics module 22 as appropriate. Rule based pattern correlation module 26 may enable labels 32 corresponding to correlated patterns. Labels 32 may be used in a natural language processing module 34 to extract results to business queries 36.

As used herein, the term “big data” encompasses a collection of large and complex data sets (e.g., collection of data) that cannot be processed using on-hand database management tools or traditional data processing applications within a reasonable time frame. Big data sizes can range from a few dozen terabytes to many peta bytes of data in a single data set. Big data can comprise high volume, high velocity, and/or high variety information assets that involve advanced (e.g., non-traditional) forms of processing to enable enhanced decision making, insight discovery and process optimization. Big data can include structured and unstructured data sets that can be incomplete or inaccessible. An example of big data includes petabytes (1,024 terabytes) or exabytes (1,024 petabytes) of data consisting of billions to trillions of records of millions of people from different sources (e.g. Web, sales, customer contact center, social media, mobile data, etc.).

Embodiments of system 10 can provide an advanced analytics platform based on various concepts, such as active analytics, pattern detection in a big data set (e.g., data set comprising a portion of big data), predictive analytics, artificial intelligence, rule based association of patterns to form business semantics, natural language processing, and big data storage and computing. Liveanalytics 12 may execute various analytical actions and correlate patterns 24(1)-24(N) identified in data sets 20(1)-20(N) without human intervention. In some embodiments, Liveanalytics 12 can comprise a general purpose engine that performs pre-programmed activities to answer a predefined set of questions for the underlying data in big data FS 18.

For purposes of illustrating the techniques of system 10, it is important to understand the communications that may be traversing the system shown in FIG. 1. The following foundational information may be viewed as a basis from which the present disclosure may be properly explained. Such information is offered earnestly for purposes of explanation only and, accordingly, should not be construed in any way to limit the broad scope of the present disclosure and its potential applications.

Big data can be so vast and unorganized that organizing it for analysis is not an easy task. For example, a substantial portion of big data can be biased, or missing context, or based on irrelevant samples. Analysis of big data can be prone to various errors, including missing relevant data, inaccurate algorithms, incorrect assumptions, etc. Moreover, making sense out of a vast store of information represented by big data can be daunting, in particular, with reference to desired parameters that are important to a specific user (or organization). For example, a retail company may collect big data on products sold at various stores over several years. A store manager at the retail company may be interested in determining the turnover of a specific category of inventory over a certain time period; a marketing manager in the retail company may analyze the same data, but may be interested in determining customer trends, such as popular products, sale strategies, etc.; a vice president of the retail company may be more interested in revenue generated at various geographical locations; and so on. Each of such analysis may be focused on the same data, but may seek various different patterns, parameters, conclusions, and predictions that are relevant to the specific user (or user role, organization, etc.). Existing methods of analysis are typically inflexible, focused on algorithms tailored to analyze big data in a specific, fixed manner, for example, that helps the vice president to determine revenue patterns; however the same algorithms may not provide the insight the store manager seeks.

Existing mechanisms such as Hadoop uses Map Reduce Jobs to perform computation over mostly unstructured big data. However, while Hadoop allows performing various analysis with complex computations, it is not relatively quick or efficient for performing multi-dimensional analytics over big data. Some analytics tools use online analytical processing (OLAP); however, such tools are too slow for real time even on partially aggregated data. Moreover, as the data is being structured at read time, the fixed initial time taken for each query makes Hadoop unusable for real time multi-dimensional analytics. In some analytics tools, the desired data may be aggregated in Hadoop and brought over to a relational database for structuring and analyzing. Multi-dimensional OLAP (MOLAP) is also sometimes used to perform real-time analysis of big data. However such existing analytics tools are not fast enough, and moreover, not flexible enough for disparate applications.

System 10 is configured to address these issues (and others) in offering a system and method for analyzing big data in a network environment. Embodiments of system 10 can extract a data set (e.g., 20(1)) from big data stored in the network (e.g., in big data FS 18), detect a pattern (e.g., 24(1)) in the data set (e.g., 20(1)), and enable labels 32 based on the pattern (e.g., 24(1)), where each label 32 indicates a specific condition associated with the big data, wherein labels 32 are searched to answer a query (e.g., business queries) regarding the big data. As used herein, the term “label” comprises meta-data associated with data in data sets 20(1)-20(N), and/or in patterns 24(1)-24(N). Each data point in data set 20(1)-20(N) may comprise one or more dimensions, each of which can describe a specific label 32.

In various embodiments, rules for correlating the pattern (e.g., 24(1)) with respective conditions may be defined, with each label 32 being enabled when the pattern (e.g., 24(1)) matches one of the rules. For example, data points in big data FS 18 may indicate sales in a specific company over 10 years in various geographical locations globally. The data points may be multi-dimensional, including dimensions for time, geographical location, store number, product SKU number, etc. A rule 1 may be defined to enable a label titled “increasing sales in Dallas in 2012” when overall sales in Dallas area stored increase over a one year period of 2012. Another rule 2 may be defined to enable a label titled “decreasing sales in Dallas in 2012” when overall sales in Dallas area stored decrease over 2012.

During operation, data set 20(1) may be extracted from big data FS 18. In one embodiment, the data points in data set 20(1) may include a subset of the various dimensions as the original data points in big data FS 18. For example, data set 20(1) may include only data points corresponding to sales in Dallas area stores over 2012. Pattern 24(1) may be generated based on data set 20(1). Rules 1 and 2 may be executed. If the sales in Dallas area stores increased in 2012, the label corresponding to rule 1 may be enabled; on the other hand, if the sales in Dallas area stores decreased in 2012, the label corresponding to rule 2 may be enabled. Business query 36 for sales in Dallas area stores in 2012 may generate a search of substantially all enabled labels, pulling up the enabled label having the specific search keywords or context.

According to various embodiments, raw data comprising the big data may be stored appropriately in any suitable storage and accessed by big data file system 18. In some embodiments, big data file system 18 may be a distributed file system, existing across multiple storage devices in a network, such as a cloud network. Big data storage can allow customers and the network to collect and store data without filtering, compressing, or otherwise manipulating the data. In addition, the data can be stored in a cloud infrastructure (e.g., public, private, or hybrid), which can relieve service providers and enterprise users from storing and managing huge and ever growing data in their separate limited resource networks.

According to various embodiments, data can be collected and stored in big data FS 18 in various suitable ways. For example, dynamic (e.g., time varying) protocol data may be collected from the wire, log data may be written to files, etc. In one example, the dynamic data may be collected using an appropriate software program residing in the customer network. The data may be correlated with a key and stored in a comma separated value (CSV) format, for example, to reduce post-processing and expensive multiline correlation. The data may be split into chunks and compressed for faster cloud upload. The compressed data may be uploaded into big data FS 18 in a cloud network.

In another example, static data or slow velocity data such as customer account data, rate tables, etc. may be stored in a relational database comprising big data FS 18. For example, the static or slow velocity data may be collected using an appropriate software program residing in the customer network, typically at a frequency that matches with the data updates. The data may be then stored directly on big data FS 18.

According to various embodiments, Liveanalytics 12 may substantially continuously fetch patterns 24(1)-24(N) and correlate them with rules to create labels 32 that can be used for answering business queries 36. 2. Liveanalytics 12 may execute algorithms to detect patterns 24(1)-24(N) in data sets 22(1)-22(N), which can be static (e.g., data set content unchanging with time) or dynamic (e.g., data set content changing with time). Data sets 22(1)-22(N) can be one dimensional (e.g., including information corresponding to a single parameter), or multidimensional (e.g., including information corresponding to more than one parameter) and can include a default time dimension.

In some embodiments, data sets 22(1)-22(N) may be specified in a manner similar to database schema definition. An example data set can include one dimensional data specified with independent data behavior. Another example data set can include complex schemas derived from complex correlations and joining of multiple data parameters. Example embodiments may allow the behavior of patterns 24(1)-24(N) to be correlated to facilitate business decisions. According to various embodiments, the specification (e.g., definition, properties, etc.) of data sets 20(1)-20(N) may indicate the particular algorithms and/or process to be run and the frequency of data collection. In various embodiments, data sets 20(1)-20(N) may be generated by executing map reduce algorithms. Data sets 20(1)-20(N) may be stored in a suitable column database, such as HBase™ or Cassandra™, for example, for better analytic performance. The data may grow over time, and can be partitioned for a preconfigured data range (e.g., daily, weekly, monthly, etc.).

According to various embodiments, gradient based iterative small data linear analysis may be performed to detect patterns 24(1)-24(N) in data sets 20(1)-20(N). In some embodiments, each pattern 24(1)-24(N) may belong to one of at least two time dimension types: time series pattern and time range patterns. The time series patterns may be stored in a multi-field data set to include various parameters, such as pattern name, start time, end time, pattern type, gradient, average, median, standard deviation, etc. (e.g., TS Pattern: Pattern: (Pattern Name, Start Time, End Time, Pattern Type, Gradient, average, median, Standard Deviation)). The pattern type can be any suitable type appropriate to the data, for example, linear growth, exponential growth, bell curve, hockey curve, etc.

The time range patterns may track one or more specific characteristics of particular attributes in a given time range. (e.g., TR Pattern: (Pattern Name, Start Time, End Time, Most Occurrences (top N), Least Occurrences (bottom N), max Frequency). For example, a time range pattern may track a single attribute (e.g., number of occurrences of Internet Protocol (IP) addresses) and may be stored as a {key, value} pair. Additional attributes may be tracked in the time range pattern, based on particular needs. Time series and time range patterns may be detected using the trend-change based approach, with the time range patterns involving determination of counts or occurrences of the keys. In various embodiments, system 10 can analyze patterns 24(1)-24(N) (e.g., time series patterns) for changes over different time periods, for example, to detect pattern acceleration, which can be a property of the relevant pattern 24(1)-24(N), and can be identified (or assigned to) the pattern name.

In some embodiments, rule based pattern correlation module 26 can include predetermined (e.g., preconfigured) rules. In other embodiments, rule based pattern correlation module 26 can include rules that may be defined based on various patterns 24(1)-24(N) identified in system 10. In yet other embodiments, rules may be specified to predict various results and/or scenarios, for example, as in a predictive analysis system. Rules may be specified to output a specific label 32 when one or more predetermined conditions are met: Rule R1:: If (condition matches), then output labels [L₁₁, L₁₂, . . . L_{1N}]. A condition includes a grouped set of pattern conditions (PCs) operated on by Boolean operations, such as and (&&), or (∥) and not (̂). An example of a condition is (((PC1 and PC2) or PC3) and (not PC4)). The result of the condition would a TRUE or FALSE. The pattern condition includes certain conditional statements are specified for a pattern's attributes and applied for a time range dependent on the specific label of interest. For example, a particular pattern condition may comprise: 1.2<Pattern Gradient<1.8.

Based on whether the condition is a TRUE or FALSE, appropriate labels 32 may be enabled. Each label may comprise short statements addressing a state or trend of data sets 20(1)-20(N). Labels 32 may be time-dependent and applicability or time range may be captured therein. A general example of labels 32 include a label statement and a corresponding time range. Examples of labels 32 include [Label Statement: Revenue Growth] corresponding to [Time Range: Last Month]; [Label Statement: Revenue Flat+Customer Churn Decrease] corresponding to [Time Range: Last Quarter]; [Label Statement: Service X in high demand, Service Y in low demand] corresponding to [Time Range: Last 8 months]. Labels 32 and associated rules may be defined (e.g., specified, indicated, configured, etc.) according to particular needs, for example, to retrieve business information.

The time range can be an absolute range or may be a relative range. The exact start dates and end dates may be specified in the absolute time range. Keywords such as last, next, first, between, since <date>, year, quarter, month, week, day, hour, etc. may indicate the time range of interest to be applied to patterns 24(1)-24(N). In some embodiments, labels 32 may include an expiry date or time frame, after which the specific label may not be valid anymore, and can be archived.

In some embodiments, labels 32 may comprise dynamic features allowing pattern characteristics to be embedded in meta-data of corresponding labels 32. An example of the dynamic feature includes: [Label Statement: Fraud from IP<Pattern Name[topKey]>] corresponding to [Time Range: Last Quarter], wherein <PatternName[topKey]>resolves to 10.5.5.5 for certain data. In some embodiments, labels 32 may include default labels enabled by system 10 for every data set 20(1)-20(N).

According to various embodiments, Al database 30 may be used to improve the pattern detection accuracy. For example, Al database 30 may be fed with learning patterns associated with complex and non-linear data sets. Sample derived data for learning may be extracted from actual data and patterns and provided by feedback module 28. Al 30 may check the learning data with actual data to confirm the accuracy of the trend-change methodology. The system can use an Al based pattern matching algorithm when the trend-change method finds high frequency trend changes with observed high randomness in the data.

According to various embodiments, business queries 36 may include natural language queries. Natural language processing module 34 may convert the natural language queries and map them against labels 32. Natural language processing module 34 may find answers for business queries 36 for which matching labels 32 are available. Some embodiments may support OLAP, including pivot table analysis in business queries 36. For example, pivot table analysis can facilitate answering multi-dimensional analytical (MDA) queries swiftly.

In some embodiments, a correlation dataset, which can correlate entries of one dataset with another dataset may be added to compute patterns 24(1)-24(N). According to various embodiments, embodiments of system 10 may utilize drill-down analytical operations. Drill-down allows navigation through details of a multi-dimensional data set. For example, users can view sales by individual products that make up a region's sales. In various embodiments, data sets 20(1)-20(N) may be categorized by one or more dimensions, for example, X, Y, Z, Z1, Z2, Z3, Z4, Z5, and so on. The data points in data sets 20(1)-20(N) may be viewed as points in a hypothetical vector space having the one or more dimensions. The X dimension can provide iterative storage and counting, for example, to optimize data recovery time. The Y dimension may maintain a value, which can comprise the heart of the corresponding data set.

Embodiments of system 10 may include the capability to drill down to various dimensions and allow pivoting based on different dimensions. Pivoting may be supported for any dimension. For example, time range data may support pivoting on the Z1 axis. In many embodiments, interpreting data in a specific dimension may involve pivoting the corresponding data set to the specific dimension. In some embodiments, patterns 24(1)-24(N) generated for Z dimension(s) can comprise top and bottom candidates.

Substantially all the Z dimensions may be counted against the Y value (e.g., value in the Y dimension may be counted or aggregated for substantially all Z dimensions when pivoted on the Z dimensions; value in the Y dimension may be counted or aggregated on the X dimension when not pivoted). For example consider a time series data comprising data collected through a router. The data set can have two attributes: (Timestamp, DataSize). The data may be cumulated for a window comprising (TimeStart, TimeEnd, TotalData). Merely for the sake of illustration and not as a limitation, assume that the data may be classified with source IP address. A data structure comprising the classified data may comprise the following: (Timestamp, DataSize, SourceIP), where Timestamp corresponds to the X dimension, DataSize corresponds to the Y dimension and SourceIP corresponds to the Z dimension. Default patterns for the data set may count the total for each interval (e.g., (TimeStart, TimeEnd, TotalData)) and may also maintain the top/bottom SourceIP data points. The resultant pattern data structure may comprise the following: (TimeStart, TimeEnd, TotalData, TopSrcIPs[ ], BottomSrcIPs[ ]) in addition to other statistical parameters collected for the window. If the pattern is pivoted on SourceIP, the new pattern data structure may comprise the following: (SrcIP, TotalDataSize, PeakUsageWindows[ ], LeastUsageWindows[ ]). Hence, values in the Y dimension (e.g., DataSize) may be aggregated in the pivoted Z dimension.

Some embodiments may include the ability to zoom to a specific value or value range within a scope of the relevant dimension. An iterative window scheme may be included when pivoting to a different dimension. Such iterative window schemes may be configured for timestamp, IP address, strings, countries, states, cities, ZIP Codes, telephone numbers, etc. Some embodiments may include a heuristic algorithm to maintain top and/or bottom pattern candidates over a predetermined period in an iterative consistent fashion.

Turning to the infrastructure of system 10, the network topology can include any number of servers, service nodes, virtual machines, switches (including distributed virtual switches), routers, and other nodes inter-connected to form a large and complex network. A node may be any electronic device, client, server, peer, service, application, or other object capable of sending, receiving, or forwarding information over communications channels in a network. Elements of FIG. 1 may be coupled to one another through one or more interfaces employing any suitable connection (wired or wireless), which provides a viable pathway for electronic communications.

Additionally, any one or more of these elements may be combined or removed from the architecture based on particular configuration needs. System 10 may include a configuration capable of TCP/IP communications for the electronic transmission or reception of data packets in a network. System 10 may also operate in conjunction with a User Datagram Protocol/Internet Protocol (UDP/IP) or any other suitable protocol, where appropriate and based on particular needs. In addition, gateways, routers, switches, and any other suitable nodes (physical or virtual) may be used to facilitate electronic communication between various nodes in the network.

Note that the numerical and letter designations assigned to the elements of FIG. 1 do not connote any type of hierarchy; the designations are arbitrary and have been used for purposes of teaching only. Such designations should not be construed in any way to limit their capabilities, functionalities, or applications in the potential environments that may benefit from the features of system 10. It should be understood that system 10 shown in FIG. 1 is simplified for ease of illustration. System 10 can include any number of servers, service nodes, virtual machines, gateways (and other network elements) within the broad scope of the embodiments.

The example network environment may be configured over a physical infrastructure that may include one or more networks and, further, may be configured in any form including, but not limited to, LANs, wireless local area networks (WLANs), VLANs, metropolitan area networks (MANs), wide area networks (WANs), virtual private networks (VPNs), Intranet, Extranet, any other appropriate architecture or system, or any combination thereof that facilitates communications in a network. In some embodiments, a communication link may represent any electronic link supporting a LAN environment such as, for example, cable, Ethernet, wireless technologies (e.g., IEEE 802.11x), ATM, fiber optics, etc. or any suitable combination thereof. In other embodiments, communication links may represent a remote connection through any appropriate medium (e.g., digital subscriber lines (DSL), telephone lines, T1 lines, T3 lines, wireless, satellite, fiber optics, cable, Ethernet, etc. or any combination thereof) and/or through any additional networks such as a wide area networks (e.g., the Internet).

In some embodiments, functionalities of the various elements illustrated in the FIGURE may be implemented (e.g., executed) separately in one or more physical devices, such as servers, or computers. In other embodiments, the functionalities of the various elements may be implemented in a distributed manner, for example, wherein portions of the operations described herein are executed on multiple devices substantially simultaneously. In yet other embodiments, the functionalities of the various elements may be implemented in a virtual manner, either separately, or in a distributed manner, with virtual machines executing instructions for the various functionalities, as appropriate.

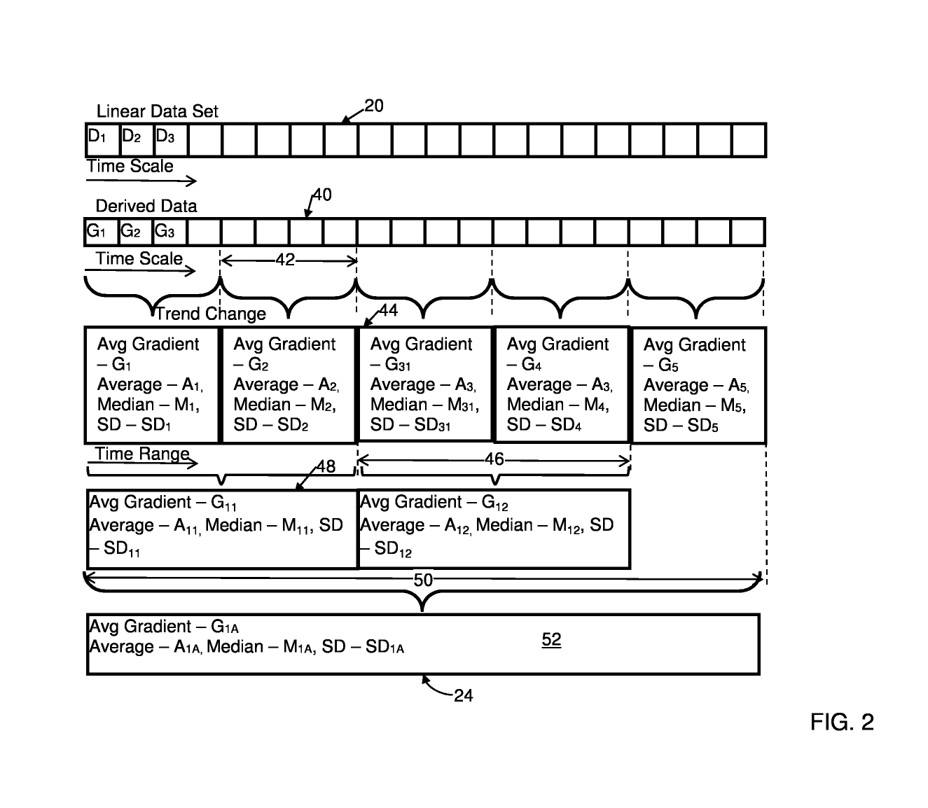

Turning to FIG. 2, FIG. 2 is a simplified block diagram illustrating example details of gradient based iterative small data linear analysis according to an embodiment of system 10. A linear data set 20 may be represented by numerous discrete data points D. A gradient data set 40 may comprise gradients (e.g., rate of change) captured between each consecutive adjacent data points {D, D} in data set 20, and aggregated suitably. Gradient fata set 40 can also (or alternatively) include other parameters derived from data points in data set 20, such as inverse tangential of gradients of each data point from a mean value, statistical parameters (e.g., regressions values, clustering information, trend changes, top or least candidates, etc.) that can assist in determining a behavior of the data in an interval. Suitable parameters may be chosen based on the data type (e.g., sales numbers, product categories, patient names, store locations, etc.) considering that no single mechanism, algorithm or parameter can be applicable for all types of data. Each data point in gradient data set 40 may include the base value (e.g., D) and the associated gradient (or other derived parameter).

Gradient data set 40 may be divided into a plurality of uniformly sized windows 42. As used herein, the term “window” comprises a block, a set, a chunk, a portion, a slice, and other such groupings of data points. The size (and number) of windows 42 may be based on any suitable parameter, for example, so that an integer number of windows may be obtained from the data points in derived data set 40. The size of windows 42 may comprise an hour's worth of data or a day's worth of data or a week's worth of data, etc. Lower window sizes can provide better accuracy.

Suitable statistical parameters (e.g., average, median, standard deviation etc.) may be calculated for each window. In an example embodiments, an average tangent inverse of substantially all gradient data points in each window may be calculated for each window. Moreover, trend change points may be noted, and stored appropriately. The trend change points may be detected by an amount of change between few consecutive derived values, which can be configurable. If a trend change is detected in one of windows 42, the statistical parameter of interest before the change and after the change may also be stored appropriately.

In some embodiments, pivoting may be used to create pattern 24 for different dimensions. A pivot operation can create pattern 24 for a new (or different) dimension than the dimension chosen initially (e.g., by default) for window creation rules applicable for the type of data. The new (or different) dimension can be chosen for a new data to be pivot enabled so that the pivoted pattern on the new (or different) dimension can be generated and updated when the pattern for the original (or initial) dimension is calculated.

The statistical parameter of interest of each window may be aggregated into a derived data set 44. In successive iterative steps, derived data set 44 may be divided into windows 46, each of which may be larger than any one of previously generated windows. Statistical parameters may be calculated in each window as before. The calculating, the aggregating into derived data sets, and dividing the derived data sets may be repeated on successively larger windows until high level pattern 24 is detected at a largest possible window size for data set 20. For example, the iterations may continue until the window size (e.g., of window 50) encompasses the entirety of data set 20. A derived data set 52 of window 50 may be generated at the last iteration. By iterating successively over the derived data sets (e.g., 40, 44, 48), a high level pattern 24 can be detected. Pattern 24 may be indicated by the statistical parameter of interest for the largest possible window size for data set 20. High level pattern 24 can also provide a direction (e.g., trend, such as increasing, decreasing, etc.) of the pattern. Within each window (e.g., 42, 44, 50, etc.), advanced level non-linear patterns like normal distribution, exponential distribution, logarithmic distribution, etc. can be detected using suitable statistical models.

In various embodiments, pattern 24 for data set 20 may be captured and stored in a tree structure, which can provide access to sub patterns if needed. Pattern 24 and any sub-pattern may be maintained in respective data sets with appropriate pattern parameters (e.g., Pattern: (Pattern Name, Start Time, End Time, Pattern Type, Gradient, average, median, Standard Deviation). In some embodiments, pattern acceleration may be maintained for growing data. Pattern acceleration can include a change in net gradient for a given time period.

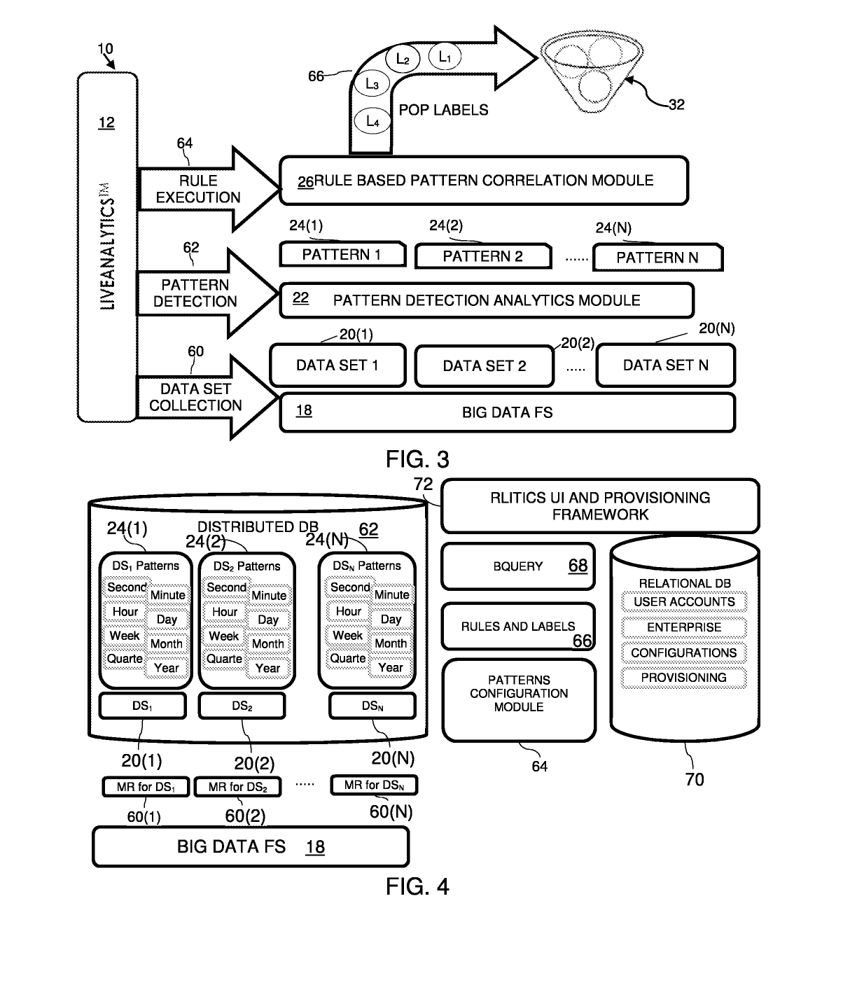

Turning to FIG. 3, FIG. 3 is a simplified diagram illustrating example operations and details of an embodiment of system 10. In various embodiments, the data set extraction, pattern detection, and label enabling may be performed substantially continuously in time. At 60, Liveanalytics 12 may perform data set collection on big data FS 18 to generate data sets 20(1)-20(N). At 62, Liveanalytics 12 may provide appropriate pattern detection algorithms to pattern detection analytics module 22 to generate patterns 24(1)-24(N). At 64, Liveanalytics 12 may co-ordinate rule execution by rule based pattern correlation module 26. At 66, labels 32 may be output from rule based pattern correlation module 26. In various embodiments, operations 60, 62, 64, and 66 may be executed substantially continuously.

Turning to FIG. 4, FIG. 4 is a simplified block diagram illustrating example details of an embodiment of system 10. According to an example embodiment, big data FS 18 may comprise an unstructured or semi-structured data storage on a distributed file system (DFS) (e.g., Hadoop DFS). A plurality of MapReduce (MR) jobs 60(1)-60(N) may perform distributed computing and transfer processed output to data sets 20(1)-20(N), which may be stored in a distributed database 62 (e.g., Cassandra). (MapReduce is a programming model for processing large data sets with a parallel, distributed algorithm on a cluster. A MapReduce program comprises a Map( ) procedure that performs filtering and sorting and a Reduce( ) procedure that performs a summary operation.) MR jobs 60(1)-60(N) marshals distributed servers, running various tasks in parallel, managing communications and data transfers between the various parts of the distributed file system, providing for redundancy and failures, and overall management of the whole process. Distributed database 62 may also maintain patterns 24(1)-24(N). Each pattern 24(1)-24(N) may be stored in the context of timelines, for example, represented in seconds, hours, minutes, days, weeks, months, quarters, years, etc., as appropriate.

According to various embodiments, a patterns configuration module 64 may store configurations and algorithms (e.g., logic, software code, instructions, etc.) related to patterns 24(1)-24(N). A rules and labels module 66 may store configurations and algorithms related to the rules and labels 32 of system 10. A bquery module 68 may store instructions for retrieving data sets 20(1)-20(N) and patterns 24(1)-24(N) (and other information) from distributed database 62. A relational database 70 may be used for storing user configurations, provisioning information, enterprise accounts, user accounts, and other information related to users and/or customers of system 10. A user interface (UI) framework 72 (Rlitics UI and provisioning framework) may permit user interface with system 10.

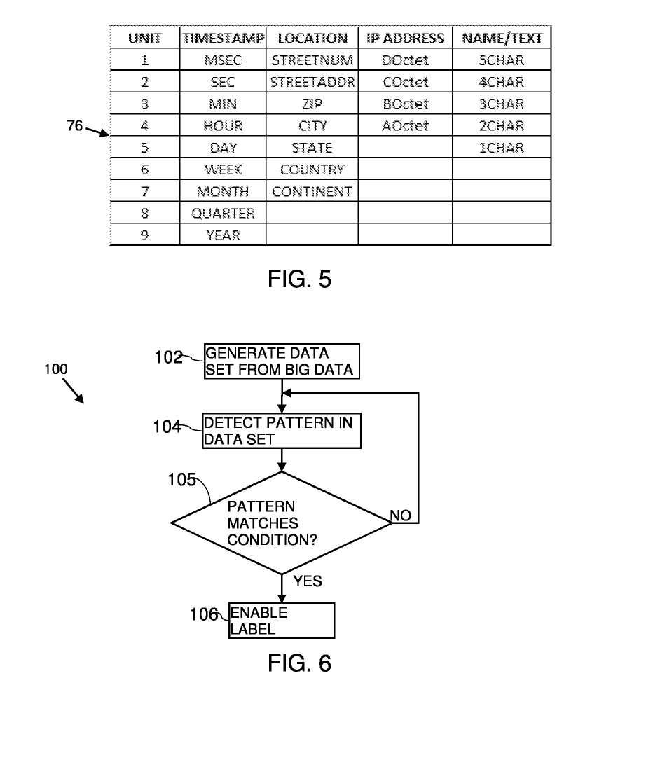

Turning to FIG. 5, FIG. 5 is a simplified diagram illustrating example window parameters 76 according to embodiments of system 10. In embodiments wherein the X-dimension (e.g., pivot dimension) is not a time-based parameter, there may be no standardized way to slicing the data points into appropriate windows for performing gradient based iterative small data analysis. Some embodiments may include default algorithms based on few X-dimension data types such as example window parameters 76. Example window parameters 76 can include timestamp in milliseconds (MSEC), seconds (SEC), . . . year; location, including street number (STREETNUM), street address (STREETADDR), . . . continent; IP address; name/text, comprising any suitable characters), etc.

Turning to FIG. 6, FIG. 6 is a simplified flow diagram illustrating example operations 100 that may be associated with embodiments of system 10. At 102, data sets 20(1)-20(N) may be generated from big data stored in big data file system 18. At 104, patterns 24(1)-24(N) may be detected. At 105, a determination may be made if any of patterns 24(1)-24(N) matches one or more conditions (or rules). If not, the operations may revert back to 104. If one or more conditions is matched, at 106, one or more corresponding labels 32 may be enabled.

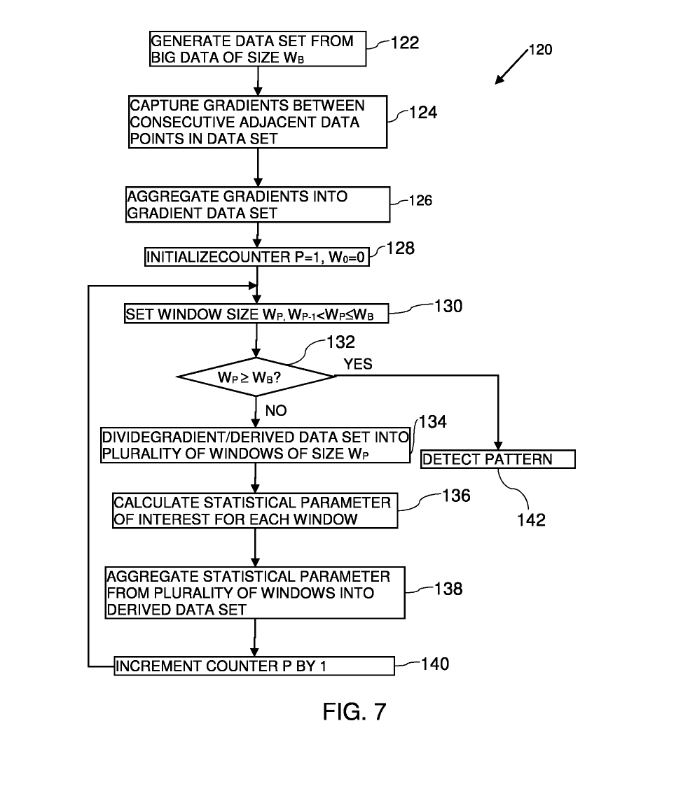

Turning to FIG. 7, FIG. 7 is a simplified flow diagram illustrating example operations 120 that may be associated with embodiments of system 10. At 122, data set 20 of size WB may be generated from big data. Size WB is an indication of the time window (or other window parameter) relevant to data set 20. For example, WB may represent a window size of 1 year. In another example, WB may represent a continent. At 124, gradients between consecutive adjacent data points in data set 20 may be captured. At 126, the gradients may be aggregated into gradient data set 44. At 128, a counter P (e.g., iteration counter) may be initialized to 1. In addition, a window size variable W₀ may be initialized to zero.

At 130, a window size W_{P} may be initialized and set to be smaller than WB, and larger than W_{P-1}. According to various embodiments, the smaller the starting window size, the more accurate the resultant pattern derivation. At 132, a determination may be made whether the window size is equal to or greater than W_{B}. If not, at 134, gradient data set 40 may be divided into plurality of windows 42, each window having size W_{P}. At 136, a statistical parameter of interest (e.g., average gradient, median of gradient, etc.) may be calculated. At 138, the statistical parameter of interest from the plurality of windows may be aggregated into a derived data set. At 140, the counter P may be advanced by 1 to P+1. The operations may revert to 130, with a new window size enlarged to a larger size than the window size in the previous iteration. The operations may continue until the window size becomes the largest possible window size for data set 20. In other words, W_{P} is either greater than, or equal to WB. At 142, pattern 24 may be detected, for example, based on the statistical parameter of interest.

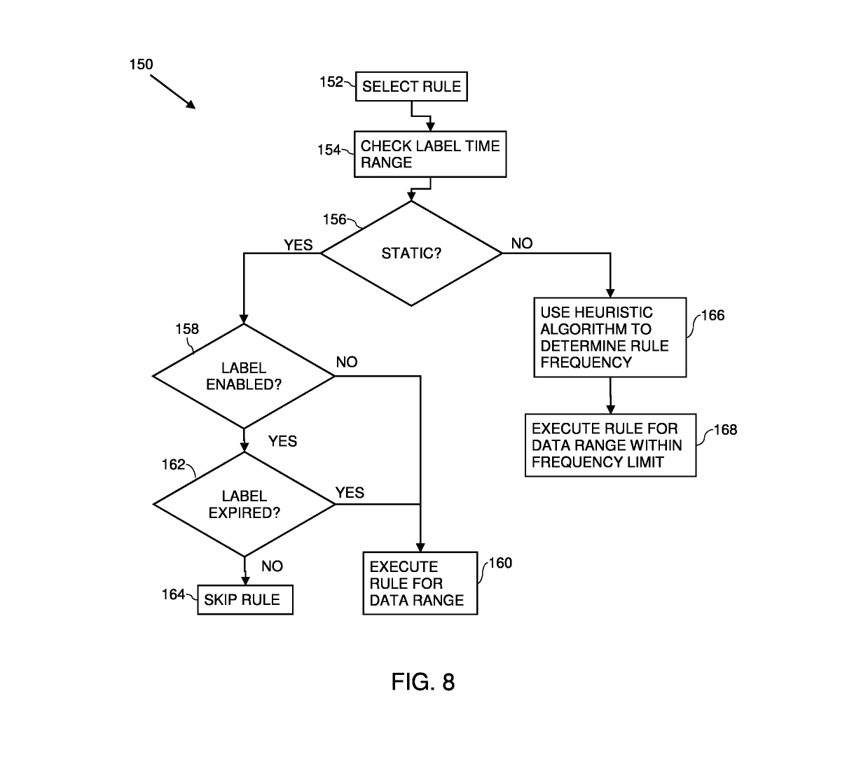

Turning to FIG. 8, FIG. 8 is a simplified flow diagram illustrating example operations 150 that may be associated with embodiments of system 10. In some embodiments, enabling labels 32 may comprise selecting a rule associated with a static time range, executing the rule for the data set (e.g., 20(1)) in the time range, and enabling the label associated with the rule if the condition associated with the rule is met by the pattern (e.g., 24(1)). In some other embodiments, enabling labels 32 may comprise selecting a rule associated with a dynamic time range, determining a rule frequency at which to execute the rule, executing the rule for the data set in the time range at the rule frequency, and enabling the label associated with the rule at each execution if the condition associated with the rule is met by the pattern.

At 152, a rule may be selected. At 154, a label time range may be checked. If the label time range is static as determined at 156, at 158, a determination may be made whether the label is already enabled. If not, the rule may be executed for the data range of interest at 160. If the label is already enabled, a determination may be made at 162 if the label is expired. If the label is expired, the operations may revert to 160, and the rule may be executed. If the label is not expired, the rule may be skipped at 164. Turning back to 156, if the label time range is dynamic, at 166, a heuristic algorithm may be used to determine a rule frequency (e.g., frequency at which to run the rule). At 168, the rule may be executed for the data range of interest within the frequency limit determined at 166.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments. Note also that an ‘application’ as used herein this Specification, can be inclusive of any executable file comprising instructions that can be understood and processed on a computer, and may further include library modules loaded during execution, object files, system files, hardware logic, software logic, or any other executable modules.

In example implementations, at least some portions of the activities outlined herein may be implemented in software in, for example, Liveanalytics 12. In some embodiments, one or more of these features may be implemented in hardware, provided external to these elements, or consolidated in any appropriate manner to achieve the intended functionality. The various network elements may include software (or reciprocating software) that can coordinate in order to achieve the operations as outlined herein. In still other embodiments, these elements may include any suitable algorithms, hardware, software, components, modules, interfaces, or objects that facilitate the operations thereof.

Furthermore, Liveanalytics 12 described and shown herein (and/or their associated structures) may also include suitable interfaces for receiving, transmitting, and/or otherwise communicating data or information in a network environment. Additionally, some of the processors and memory elements associated with the various nodes may be removed, or otherwise consolidated such that a single processor and a single memory element are responsible for certain activities. In a general sense, the arrangements depicted in the FIGURES may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

In some of example embodiments, one or more memory elements (e.g., memory element 16) can store data used for the operations described herein. This includes the memory element being able to store instructions (e.g., software, logic, code, etc.) in non-transitory computer readable media, such that the instructions are executed to carry out the activities described in this Specification. A processor can execute any type of instructions associated with the data to achieve the operations detailed herein in this Specification. In one example, processors (e.g., processor 14) could transform an element or an article (e.g., data) from one state or thing to another state or thing.

In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

These devices may further keep information in any suitable type of non-transitory computer readable storage medium (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in system 10 could be provided in any database, register, table, cache, queue, control list, or storage structure, based on particular needs and implementations, all of which could be referenced in any suitable timeframe. Any of the memory items discussed herein should be construed as being encompassed within the broad term ‘memory element.’ Similarly, any of the potential processing elements, modules, and machines described in this Specification should be construed as being encompassed within the broad term ‘processor.’

It is also important to note that the operations and steps described with reference to the preceding FIGURES illustrate only some of the possible scenarios that may be executed by, or within, the system. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion. Substantial flexibility is provided by the system in that any suitable arrangements, chronologies, configurations, and timing mechanisms may be provided without departing from the teachings of the discussed concepts.

Although the present disclosure has been described in detail with reference to particular arrangements and configurations, these example configurations and arrangements may be changed significantly without departing from the scope of the present disclosure. Moreover, although system 10 has been illustrated with reference to particular elements and operations that facilitate the communication process, these elements, and operations may be replaced by any suitable architecture or process that achieves the intended functionality of system 10.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
extracting a data set from big data stored in a network environment;
detecting a pattern in the data set; and
enabling labels based on the pattern, wherein each label indicates a specific condition associated with the big data, wherein the labels are searched to answer a query regarding the big data.

2. The method of claim 1, further comprising:
defining rules for correlating the pattern with respective conditions, wherein each label is enabled when the pattern matches one of the rules.

3. The method of claim 2, wherein enabling labels comprises:
selecting a rule associated with a static time range for the corresponding label;
executing the rule for the data set in the time range; and
enabling the label associated with the rule if the condition associated with the rule is met by the pattern.

4. The method of claim 2, wherein enabling labels comprises:
selecting a rule associated with a dynamic time range for the corresponding label;
determining a rule frequency at which to execute the rule;
executing the rule for the data set in the time range at the rule frequency; and
enabling the label associated with the rule at each execution if the condition associated with the rule is met by the pattern.

5. The method of claim 1, wherein the labels are time bound.

6. The method of claim 1, further comprising:
using artificial intelligence algorithms comprising learning patterns to improve the pattern detection.

7. The method of claim 1, wherein the extracting, the detecting and the enabling are performed substantially continuously in time.

8. The method of claim 1, wherein the pattern comprises at least one type from a group consisting of a time series pattern, and a time range pattern.

9. The method of claim 8, wherein the time series pattern is stored in a multi-field data set comprising a pattern name, a start time, an end time, a pattern type, a gradient, an average, a median, and a standard deviation, wherein the time range pattern is stored in a multi-field data set comprising a pattern name, a start time, an end time, a most number of occurrences, a least number of occurrences, and a maximum frequency.

10. The method of claim 1, wherein detecting the pattern comprises:
capturing gradients between each consecutive adjacent data points in the data set;
aggregating the gradients into a gradient data set;
dividing the gradient data set into windows;
calculating a statistical parameter of interest for each window;
aggregating the statistical parameters into a derived data set; and
repeating the dividing, the calculating and the aggregating on derived data sets over windows of successively larger sizes until a pattern is detected at a largest possible window size for the data set.

11. The method of claim 10, wherein the pattern is indicated by the statistical parameter of interest for the largest possible window size for the data set.

12. The method of claim 1, further comprising:
drilling down to various dimensions of the data set, wherein the data set is multi-dimensional; and
pivoting to at least one of the dimensions to view the data set.

13. Non-transitory media encoded in logic that includes instructions for execution that when executed by a processor, is operable to perform operations comprising:
extracting a data set from big data stored in a network environment;
detecting a pattern in the data set; and
enabling labels based on the pattern, wherein each label indicates a specific condition associated with the big data, wherein the labels are searched to answer a query regarding the big data.

14. The media of claim 13, wherein the operations further comprise:
defining rules for correlating the pattern with respective conditions, wherein each label is enabled when the pattern matches one of the rules.

15. The media of claim 13, wherein detecting the pattern comprises:
capturing gradients between each consecutive adjacent data points in the data set;
aggregating the gradients into a gradient data set;
dividing the gradient data set into windows;
calculating a statistical parameter of interest for each window;
aggregating the statistical parameters into a derived data set; and
repeating the dividing, the calculating and the aggregating on derived data sets over windows of successively larger sizes until a pattern is detected at a largest possible window size for the data set.

16. The media of claim 13, wherein the extracting, the detecting and the enabling are performed substantially continuously in time.

17. An apparatus, comprising:
a memory element for storing data; and
a processor that executes instructions associated with the data, wherein the processor and the memory element cooperate such that the apparatus is configured for:
extracting a data set from big data stored in a network environment;
detecting a pattern in the data set; and
enabling labels based on the pattern, wherein each label indicates a specific condition associated with the big data, wherein the labels are searched to answer a query regarding the big data.

18. The apparatus of claim 17, further configured for:
defining rules for correlating the pattern with respective conditions, wherein each label is enabled when the pattern matches one of the rules.

19. The apparatus of claim 17, wherein detecting the pattern comprises:
capturing gradients between each consecutive adjacent data points in the data set;
aggregating the gradients into a gradient data set;
dividing the gradient data set into windows;
calculating a statistical parameter of interest for each window;
aggregating the statistical parameters into a derived data set; and
repeating the dividing, the calculating and the aggregating on derived data sets over windows of successively larger sizes until a pattern is detected at a largest possible window size for the data set.

20. The apparatus of claim 17, wherein the extracting, the detecting and the enabling are performed substantially continuously in time.
